(19) United States
(12) Patent Application Publication
(10) Pub. No.: US 2026/0261340 A1
(43) Pub. Date: Sep. 3, 2026

(54) OPTICAL TRANSMISSION DEVICE AND OPTICAL TRANSMISSION METHOD

(71) Applicant: NTT, Inc., Tokyo (JP)

(72) Inventors: Haruka MINAMI, Musashino-shi, Tokyo (JP); Takeshi SEKI, Musashino-shi, Tokyo (JP)

(21) Appl. No.: 19/489,939

(22) PCT Filed: Jun. 5, 2023
(86) PCT No.: PCT/JP2023/020896

§ 371 Date: Dec. 4, 2025

(51) Int. Cl. H04B 10/079; H04B 10/294

(52) U.S. Cl. CPC H04B 10/07957; H04B 10/0797; H04B 10/294

(57) ABSTRACT

An optical transmission device (100) includes: an input light intensity monitor (120) that adjusts light intensity of a transmission wavelength signal input to an optical relay node; a wavelength conversion unit (130) that converts a wavelength of the transmission wavelength signal whose light intensity has been adjusted by the input light intensity adjustment unit; a WSS (140) that divides the transmission wavelength signal to be relayed into a transmission wavelength signal whose wavelength is the same as that before wavelength conversion and a monitoring wavelength signal other than the transmission wavelength signal; an output light intensity monitor (160) that adjusts light intensity of the transmission wavelength signal separated by the WSS (140); a monitor measuring instrument (150) that measures transmission quality of the monitoring wavelength signal separated by the WSS (140); and a control unit (110) that controls the input light intensity monitor (120), the WSS (140), and the output light intensity monitor (160).

### TECHNICAL FIELD

The present invention relates to an optical transmission device and an optical transmission method.

### BACKGROUND ART

In an optical transmission system in which a transmission node and a reception node are connected by a relatively-long-distance optical fiber cable, and an optical signal is transmitted, it is expected that the optical signal is largely attenuated in the middle of the transmission path and a transmission quality is deteriorated. Therefore, in order to reliably deliver the optical signal transmitted from the transmission node to the reception node, it is generally necessary to dispose one or more relay nodes in the middle of the transmission path to amplify the attenuated optical signal and to correct a bit error or the like generated in the middle of the transmission path.

In addition, since it is usually necessary to arrange the relay node at every fixed distance, a large number of relay nodes are connected to an intermediate portion of a transmission path between the transmission node and the reception node in a case where long-distance optical transmission is performed.

Each relay node of the optical transmission system usually has a function of electrical termination processing. That is, the received optical signal is temporarily converted into an electric signal, and information of the converted electric signal is relayed.

Further, when information of an electric signal is processed, transmission quality data (Pre-FEC BER, dispersion compensation amount, polarization mode dispersion amount, polarization-dependent loss) in the relay node can be acquired.

However, when each relay node executes the electrical termination processing, it is not possible to avoid an increase in a delay time associated with the relay processing of the electric signal. In addition, the power consumption increases with the relay processing of the electric signal. In addition, there is a restriction on wavelength resources available at the time of optical transmission, which hinders an increase in transmission capacity.

On the other hand, in recent years, functions of an optical fiber cable and an optical transmitter are improved. Therefore, there is a tendency to increase an interval of arranging the relay nodes having the function of electrical termination processing. As a result, since the number of nodes to be relayed while performing the electrical termination processing is reduced, power saving, a large capacity, and a low delay of the network can be achieved.

Meanwhile, for example, Non-Patent Literature 1 discloses a technology of an optical transport network in which electrical termination processing in an optical node device is omitted. In addition, in order to efficiently use limited wavelength resources, Non-Patent Literature 1 discloses introduction of a wavelength conversion function for converting a wavelength of an optical signal into another wavelength in a passing optical node device.

By the way, when a fault occurs in the optical transmission system, it is necessary to specify a fault location. For this purpose, it is necessary to first separate the entire length of the long-distance transmission path into a plurality of sections for each relay node, and to discriminate the presence or absence of failure occurrence for each section.

When each relay node implements a function of electrical termination processing, transmission quality data can be acquired for each relay node. By comparing the transmission quality data of the relay nodes, it is possible to discriminate the presence or absence of the failure occurrence for each section.

However, the transmission quality data at the point cannot be obtained for the relay node that does not implement the function of the electrical termination processing. Therefore, a large number of optical transmission devices are included in each of the sections in which the presence or absence of a failure can be discriminated, or the length of the optical fiber cable for each section becomes very long. Therefore, it is difficult to specify the fault location.

Therefore, for example, it is considered to arrange an optical splitter in the relay node. That is, one optical signal received by the relay node is branched into two paths by the optical splitter, a main signal of one path is relayed as an optical signal, and an optical signal of the other path is converted into an electrical signal and used for acquisition of transmission quality data. As a result, it is possible to reduce a signal delay of an optical main signal caused by the relay. However, since the light intensity of the optical main signal relayed when the input optical signal passes through the optical splitter decreases, the transmission quality deteriorates at the relay node.

### Configuration of Optical Transmission System

FIG. 7 is a diagram illustrating a configuration example of a general optical transmission system 1A.

As illustrated in FIG. 7, in the optical transmission system 1A, seven optical transmission devices 10-1, 10-2, 10-3, 10-4, 10-5, 10-6, and 10-7 are arranged as an example, and are connected in series to each other via a common optical fiber cable 15. In addition, a network controller 20 is connected to each of the optical transmission devices 10-1 to 10-7 in order to manage a communication network including these optical transmission devices 10-1 to 10-7.

For example, in a case where data is transmitted from the optical transmission device 10-1 on one end side of the communication network to the optical transmission device 10-7 on the other end side, the optical transmission device 10-1 serves as a transmission node and the optical transmission device 10-7 serves as a reception node. Furthermore, each of the optical transmission devices 10-2 to 10-6 between the transmission node and the reception node is used as a relay node.

The optical transmission device 10-1 of the transmission node converts data to be transmitted from an electric signal into an optical signal having a predetermined wavelength inside a transponder (TPD) 11, and sends out the optical signal to the optical fiber cable 15. The optical transmission device 10-7 of the reception node receives an optical signal from the optical fiber cable 15, converts the optical signal into an electric signal by a transponder 11 in the optical transmission device 10-7, and acquires reception data.

When the distance of optical signal transmission increases, the light intensity decreases, and transmission quality such as a bit error rate (BER) deteriorates. Furthermore, when the light intensity significantly deteriorates and the bit error rate significantly increases, the optical transmission device 10-7 of the reception node cannot correctly receive transmitted data.

Therefore, the optical transmission devices 10-2 to 10-6 of the relay nodes perform predetermined relay processing. Specifically, each relay node amplifies the light intensity of the optical signal received at each relay position, and restores original data without a bit error by predetermined error correction processing.

However, in order to perform error correction processing or the like, it is necessary to perform electrical termination processing of an optical signal to be transmitted. Specifically, the optical transmission devices 10-2 to 10-6 convert an optical signal into an electric signal in the transponder 11, process data of the obtained electric signal, and perform error correction processing and the like. Further, the optical transmission devices 10-2 to 10-6 convert the processed electric signal into an optical signal again, and send out the optical signal to the optical fiber cable 15 on the downstream side as a relay output.

When the electrical termination processing as described above is performed, it is possible to reliably correct an error generated during transmission and to recover the light intensity. It is also possible to obtain transmission quality data. However, a relatively large delay occurs in the signal inside the transponder 11 along with the processing of the electric signal. In addition, as the transmission distance increases, the number of times of relaying increases, and thus the delay time increases. In the example of the optical transmission system 1A, since the optical transmission devices 10-3 and 10-5 each including the transponder 11 as the relay node exist between the transmission node and the reception node, the delay time is twice as long as the case where the relay processing including the electrical termination processing is performed only once.

In recent years, since the functions of the optical fiber cable 15 and the transmitter that transmits an optical signal have been improved, it is possible to reduce the number of relays of the relay node including the electrical termination processing even in a case where relatively long distance optical transmission is performed. Therefore, the configuration of the optical transmission system 1A illustrated in FIG. 7 can be improved as in an optical transmission system 1B of FIG. 8.

FIG. 8 is a diagram illustrating a configuration example of an optical transmission system 1B obtained by improving the optical transmission system 1A of FIG. 7.

In the optical transmission system 1B illustrated in FIG. 8, the transponder 11 exists in the optical transmission devices 10-1 and 10-7, but the transponder 11 does not exist in the other optical transmission devices 10-2 to 10-6. That is, in a case where an optical signal is transmitted from the optical transmission device 10-1 of the transmission node to the optical transmission device 10-7 of the reception node, relay including electrical termination processing is not performed even once in the middle. Therefore, the delay time associated with the optical signal transmission of the optical transmission system 1B is greatly reduced as compared with the optical transmission system 1A.

In the optical transmission system 1B, since each of the optical transmission devices 10-2 to 10-6 does not have the transponder 11 and does not perform the electrical termination processing, the transmission quality data cannot be obtained at the position of the relay node of each of the optical transmission devices 10-2 to 10-6.

When a communication fault occurs, the network controller 20 normally performs transmission section segmentation to narrow down candidates of a location where the fault has occurred based on transmission quality data detected at a location of each node used for transmission of an optical signal. However, in the case of the optical transmission system 1B, since the transmission quality data at the relay position of each of the optical transmission devices 10-2 to 10-6 cannot be obtained, it is not possible to discriminate which section between the output of the optical transmission device 10-1 and the input of the optical transmission device 10-7 has a fault. As a result, it becomes difficult to specify the place where the fault has occurred, and it takes a long time to recover from the fault. In particular, in a case where a distance of the optical fiber cable 15 is very long, it is difficult to find the location where the fault occurs.

### Multiband Networking Technology

FIG. 9 is a diagram illustrating an example of a relationship between an optical communication link and a wavelength band in a multiband networking technology.

As illustrated in FIG. 9, it is assumed that there are three types of wavelength bands of light used for communication, that is, an L band, a C band, and an S band. The L band is a wavelength band of 1565 to 1625 nm. The C band is a wavelength band of 1530 to 1565 nm. The S band is a wavelength band of 1460 to 1530 nm.

In addition, each of the I band, the C band, and the S band has an optical path independent from each other. In the example of FIG. 9, it is assumed that there are two independent optical communication links 31 and 32.

The optical signal of each of the optical communication links 31 and 32 is adaptively band switched according to the situation, and is switched so as to straddle optical paths of a plurality of bands. The optical signal of the optical communication link 31 illustrated in FIG. 9 passes through the L-band optical path, is converted into a C-band optical signal by wavelength conversion and enters the C-band optical path, and is further converted into an S-band optical signal by wavelength conversion and enters the S-band optical path. This light is converted into an L-band optical signal through next wavelength conversion and enters the L-band optical path, and is converted into an electric signal with photonic exchange (Ph-EX), processed, and output. The Ph-EX is a component in which electric processing such as exchange, multiplexing, or switching is minimized.

In addition, the optical signal of the optical communication link 32 having the C-band wavelength passes through the C-band optical path, is converted into an S-band optical signal by wavelength conversion, enters the S-band optical path, is converted into an electric signal by the Ph-EX, and is processed.

By using the technology as illustrated in FIG. 9, the optical transmission system can efficiently use limited wavelength resources. Specifically, the accommodation traffic amount of the transmission path can be increased by about 30%. In addition, since the electrical termination processing can be omitted at the position of each communication node and the optical signal can be processed as it is, effects such as power saving, large capacity, and low delay of the network can be expected. However, the optical transmission device at each node position needs to implement a function of wavelength-converting an optical signal.

FIG. 10 is a diagram illustrating a configuration example of the optical transmission system 1 including an all-optical wavelength conversion unit 13.

As illustrated in FIG. 10, the optical transmission system 1 includes five optical transmission devices 41, 42, 43, 44, and 45 and a network controller 20. The five optical transmission devices 41 to 45 are arranged in a line at positions separated from each other by a certain distance, for example. In addition, the optical transmission devices 41 to 45 are connected in series to each other via one optical fiber cable 15 used as a transmission path of an optical signal.

The network controller 20 manages the entire optical communication network including the optical transmission devices 41 to 45 and the optical fiber cable 15. The network controller 20 can generate information useful for specifying an occurrence place of a fault, for example, when some fault occurs on the optical communication network.

For example, in a case where data is transmitted from the optical transmission device 41 on one end side of the communication network to the optical transmission device 45 on the other end side, the optical transmission device 41 serves as a transmission node and the optical transmission device 45 serves as a reception node. In addition, each of the optical transmission devices 42 to 44 between the transmission node and the reception node is used as a relay node.

The optical transmission device 41 of the transmission node converts data to be transmitted from an electric signal into an optical signal having a predetermined wavelength inside the transponder 11, and sends out the optical signal to the optical fiber cable 15. The optical transmission device 45 of the reception node receives the optical signal from the optical fiber cable 15, converts the optical signal into the electric signal with the transponder 11 in the optical transmission device 45, and acquires reception data.

In the configuration illustrated in FIG. 10, an all-optical wavelength conversion unit 13 having a function of all-optical wavelength conversion (AO-WC) is provided inside the optical transmission device 43 used as one relay node.

The all-optical wavelength conversion unit 13 in the optical transmission device 43 can execute wavelength conversion processing on an input optical signal Oin with a wavelength λ1 input from the optical fiber cable 15 into the optical transmission device 43, as an optical signal, generate an optical signal with a wavelength λ2 different from the input, and send out the optical signal as a transmission optical signal Oo2 with the wavelength λ2 to the downstream-side optical fiber cable 15. In addition, the all-optical wavelength conversion unit 13 illustrated in FIG. 10 can extract an unnecessary light component different from the optical main signal relayed inside the optical transmission device 43 and input the unnecessary light component to a detector 11A in the optical transmission device 43. The detector 11A has a function of electrical termination processing similarly to the transponder 11, but does not have a function of sending out an optical signal. That is, the detector 11A has a function of converting an input optical signal into an electric signal and a function of processing the electric signal to detect transmission quality data.

Since the optical transmission device 43 relays the optical main signal to be relayed as it is and sends out the optical main signal to the optical fiber cable 15 on the downstream side without performing electrical termination processing on the optical main signal, it is possible to prevent an increase in delay due to the relay processing. In addition, since it is not necessary to use an optical splitter to extract an optical signal input to the detector 11A as described later, it is possible to prevent a decrease in the light intensity of the optical main signal.

In addition, since the all-optical wavelength conversion unit 13 extracts an unnecessary light component different from the optical main signal to be relayed and inputs the unnecessary light component to the detector 11A in the optical transmission device 43, the detector 11A can detect transmission quality data at the node position of the optical transmission device 43.

Therefore, the network controller 20 can acquire the transmission quality data of the relay node such as the optical transmission device 43 that does not perform the electrical termination processing. For example, in a case where a fault occurs, the network controller 20 can discriminate the presence or absence of the fault occurrence for each section, on the basis of the transmission quality data at the position of each relay node.

### Configuration of All-Optical Wavelength Conversion Unit

FIG. 11 is a diagram illustrating a configuration example of the all-optical wavelength conversion unit 13 included in the optical transmission system 1 of FIG. 10.

As illustrated in FIG. 11, the all-optical wavelength conversion unit 13 includes an excitation light source 14, an optical fiber 15A, an optical multiplexer 16, a nonlinear optical medium 17, an optical demultiplexer 18, and an optical fiber 15B.

The all-optical wavelength conversion unit 13 is an all-optical wavelength conversion device including the nonlinear optical medium 17 on which both light of the optical main signal to be relayed and light of the excitation light emitted from the excitation light source 14 can be simultaneously incident.

The excitation light source 14 generates excitation light Oe having a predetermined wavelength λe. The excitation light Oe generated by the excitation light source 14 enters the optical multiplexer 16 through the optical fiber 15A. The wavelength λe of the excitation light Oe is different from the wavelength λ1 of the input optical signal Oin. In addition, the light intensity of the excitation light Oe is sufficiently larger than that of the input optical signal Oin.

The optical multiplexer 16 generates light obtained by multiplexing the input optical signal Oin input from the optical fiber cable 15 and the excitation light Oe input from the optical fiber 15A, and sends out the light to the incident end of the nonlinear optical medium 17.

The nonlinear optical medium 17 has nonlinear optical characteristics and can generate an optical signal having a wavelength different from that of incident light. As a representative example, any one of a highly nonlinear fiber (HNLF), periodically poled lithium niobate (PPLN), and a semiconductor optical amplifier (SOA) can be used as the nonlinear optical medium 17.

The optical demultiplexer 18 is connected to a light emission side of the nonlinear optical medium 17 that is an all-optical wavelength conversion device. Emission light Cout emitted from an output end of the nonlinear optical medium 17 is input into the optical demultiplexer 18. The optical demultiplexer 18 demultiplexes the incident light using its wavelength selection characteristics, and extracts two types of optical signals. That is, the transmission optical signal Oo2 having the wavelength λ2 and the emission light Oo1 having the wavelength λ1 are emitted from different output terminals of the optical demultiplexer 18.

The wavelength λ2 of the transmission optical signal Oo2 is generated on the basis of the wavelength of the input optical signal Oin, the wavelength λe of the excitation light Oe, and the nonlinear optical characteristics of the nonlinear optical medium 17. When the input optical signal Oin having the wavelength λ1 passes through the nonlinear optical medium 17 together with the excitation light Oe, the wavelength λ2 of the wavelength-converted transmission optical signal Oo2 is generated. Furthermore, emission light of the nonlinear optical medium 17 includes an optical component having the wavelength λ1 same as that before the wavelength conversion.

The transmission optical signal Oo2 having the wavelength λ2 output from the optical demultiplexer 18 is sent out from the output of the optical transmission device 43 to the optical fiber cable 15 on the downstream side as a relay output. In addition, the emission light Oo1 having the wavelength λ1 output from the optical demultiplexer 18 is input to the detector 11A in the optical transmission device 43 via the optical fiber 15B.

As described above, by using the all-optical wavelength conversion unit 13 illustrated in FIG. 11, the wavelength of the optical main signal relayed by the optical transmission device 43 can be converted from λ1 to λ2 as it is without performing electrical termination processing on the optical main signal, and an increase in delay can be prevented. In addition, the emission light Oo1 having the same wavelength λ1 as that before the wavelength conversion output from the all-optical wavelength conversion unit 13, that is, an unnecessary light component other than the main signal can be input to the detector 11A. The detector 11A can convert the input emission light Oo1 having the wavelength λ1 into an electric signal therein and perform various processing in the form of an electric signal. As a result, transmission quality data at the relay node position of the optical transmission device 43 is obtained.

However, the wavelength λ2 of the optical main signal sent out by the relay node is different from the wavelength λ1 of light other than the main signal input to the detector 11A. Therefore, a correlation between the transmission quality detected for the wavelength λ1 and the transmission quality detected for the wavelength λ2 is specified in advance, and the transmission quality data detected by the detector 11A is converted into transmission quality data of an optical signal to be relayed on the basis of the correlation. This conversion processing may be performed inside the detector 11A or on the network controller 20 side.

### CITATION LIST

### Non Patent Literature

Non Patent Literature 1: Experimental Demonstration of Cascadable PPLN-Based Inter-Band Wavelength Converters for Band-Switchable Multi-Band Optical Cross-Connect.

### SUMMARY OF INVENTION

### Technical Problem

The optical transmission system 1 illustrated in FIG. 10 provides a method for detecting an optical signal before or after wavelength conversion generated in the AO-WC of the optical node device.

However, in the above method, since the input light intensity and the output light intensity of the AO-WC are different from each other, when the AO-WC is actually introduced as an optical node device, a peripheral device (a light attenuator or an optical amplifier) for adjusting the light intensity is required.

The present invention has been made in view of such a background, and an object of the present invention is to provide an optical transmission device and an optical transmission method capable of autonomously adjusting output light intensity.

### Solution to Problem

In order to solve the above problem, there is provided an optical transmission device that is mountable in at least one optical relay node of an optical transmission system in which an optical transmission node capable of transmitting an optical signal and an optical reception node capable of receiving an optical signal are connected via an optical transmission line and one or more optical relay nodes are connected to an intermediate position of the optical transmission line, the optical transmission device including: an input light intensity adjustment unit that adjusts light intensity of a transmission wavelength signal input to the optical relay node; a wavelength conversion unit that converts a wavelength of a transmission wavelength signal whose light intensity has been adjusted by the input light intensity adjustment unit; a wavelength separation unit that divides the transmission wavelength signal to be relayed into the transmission wavelength signal having the same wavelength as that before wavelength conversion and a monitoring wavelength signal other than the transmission wavelength signal; an output light intensity adjustment unit that adjusts light intensity of the transmission wavelength signal separated by the wavelength separation unit; a measurement unit that measures transmission quality of the monitoring wavelength signal separated by the wavelength separation unit; and a control unit that controls the input light intensity adjustment unit, the wavelength separation unit, and the output light intensity adjustment unit.

### Advantageous Effects of Invention

According to the present invention, it is possible to realize an optical transmission device and an optical transmission method capable of autonomously adjusting output light intensity.

### BRIEF DESCRIPTION OF DRAWINGS

FIG. 1 is a schematic configuration diagram of an optical transmission device according to an embodiment of the present invention.

FIG. 2 is a detailed configuration diagram of the optical transmission device according to the embodiment of the present invention.

FIG. 3 is a detailed configuration diagram in which an optical amplifier is arranged in the optical transmission device according to the embodiment of the present invention.

FIG. 4 is a flowchart illustrating an operation of outputting signal light wavelength-converted by WSS to ports <2> to <n> of the optical transmission device according to the embodiment of the present invention.

FIG. 5 illustrates a configuration example of outputting signal light wavelength-converted by WSS to a port <1> of the optical transmission device according to the embodiment of the present invention.

FIG. 6 is a flowchart illustrating an operation of outputting signal light wavelength-converted by WSS to the port <1> of the optical transmission device according to the embodiment of the present invention.

FIG. 7 is a block diagram illustrating a configuration example of a general optical transmission system.

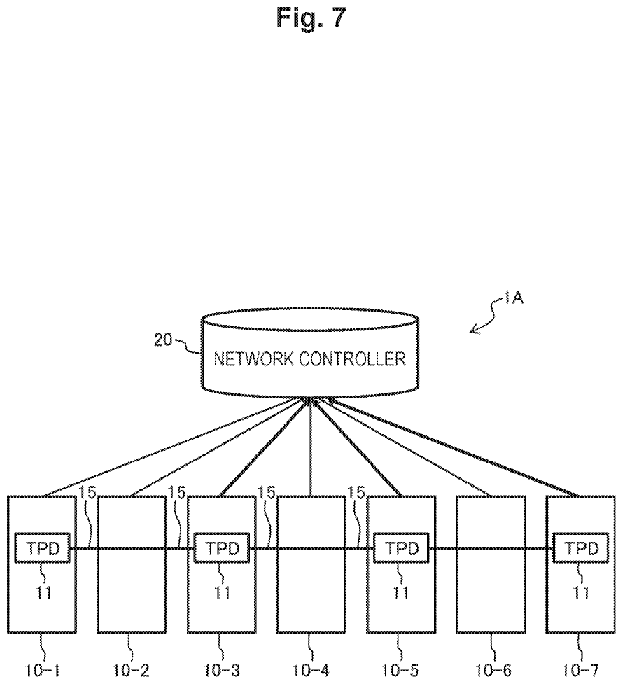

FIG. 8 is a block diagram illustrating a configuration example of a general optical transmission system.

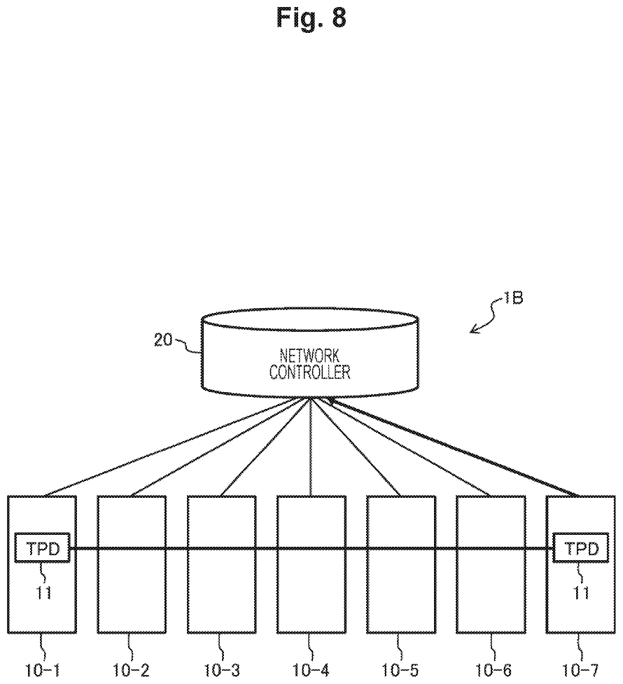

FIG. 9 is a schematic diagram illustrating an example of a relationship between an optical communication link and a wavelength band in a multiband networking technology.

FIG. 10 is a block diagram illustrating a configuration example of an optical transmission system according to the embodiment of the present invention.

FIG. 11 is a block diagram illustrating a configuration example of an all-optical wavelength conversion unit included in the optical transmission system in FIG. 10.

### DESCRIPTION OF EMBODIMENTS

Hereinafter, an optical transmission device and the like in a mode for carrying out the present invention (hereinafter, referred to as “the present embodiment”) will be described with reference to the drawings.

### Outline

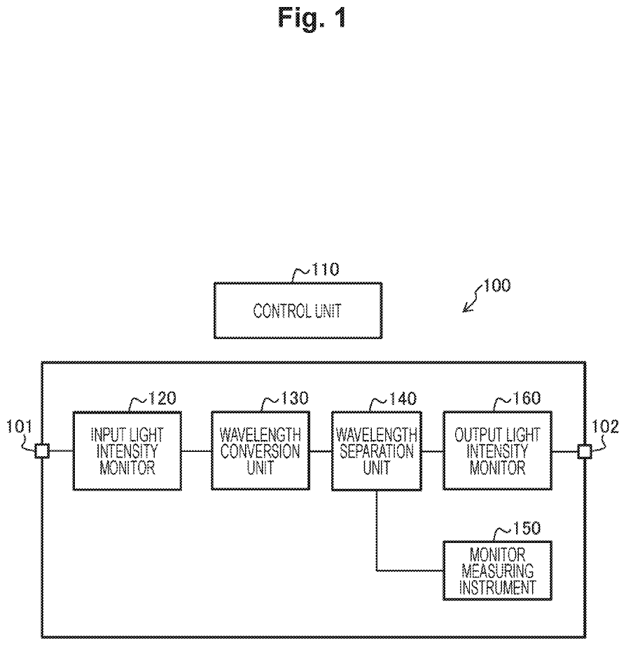

FIG. 1 is a schematic configuration diagram of an optical transmission device according to an embodiment of the present invention.

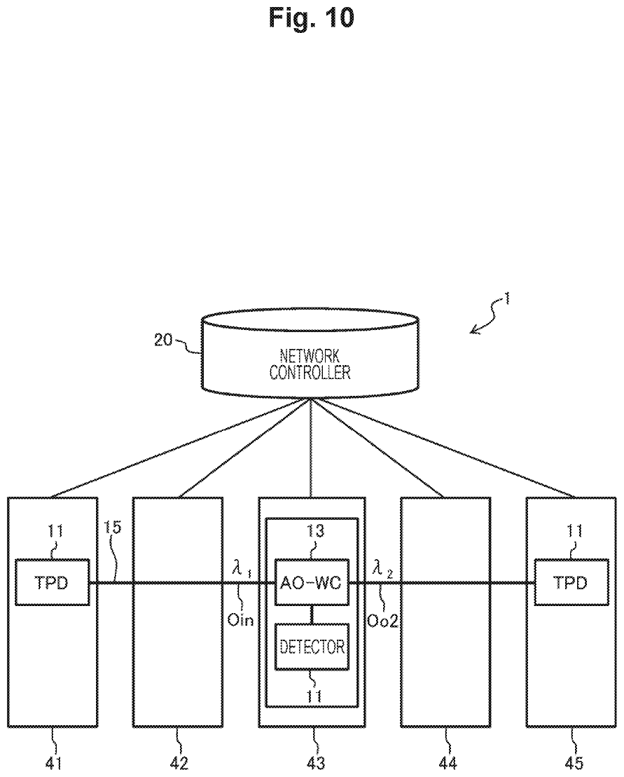

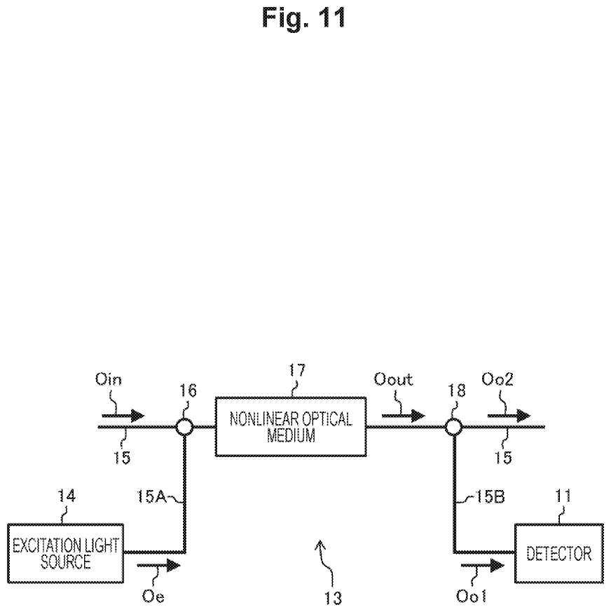

The optical transmission device according to the present embodiment is applicable to an optical transmission system 1 of FIG. 10. The same components as those in FIG. 11 are denoted by the same reference signs as those in FIG. 11.

An optical transmission device 100 is a transmission quality monitoring device that is mountable in at least one optical relay node of the optical transmission system 1 (FIG. 10) in which an optical transmission node capable of transmitting an optical signal and an optical reception node capable of receiving an optical signal are connected via an optical transmission line, and one or more optical relay nodes are connected to an intermediate position of the optical transmission line.

As illustrated in FIG. 1, the optical transmission device 100 includes a control unit 110, an optical input terminal 101, an optical output terminal 102, an input light intensity monitor 120 (input light intensity adjustment unit), a wavelength conversion unit 130, a wavelength selection switch (WSS) 140 (wavelength separation unit), a monitor measuring instrument 150 (measurement unit), and an output light intensity monitor 160 (output light intensity adjustment unit).

The input light intensity monitor 120 adjusts the light intensity of the transmission wavelength signal input to the optical relay node. Specifically, the input light intensity monitor 120 adjusts the input light intensity to be input to the wavelength conversion unit 130 with an appropriate light intensity.

The wavelength conversion unit 130 converts the wavelength of the transmission wavelength signal whose light intensity has been adjusted by the input light intensity monitor 120. Furthermore, the wavelength conversion unit 130 generates a monitoring wavelength signal from the transmission wavelength signal.

The wavelength selection switch (WSS) 140 divides the transmission wavelength signal to be relayed into a transmission wavelength signal having the same wavelength as that before the wavelength conversion and a monitoring wavelength signal (monitoring signal light) other than the transmission wavelength signal.

The monitor measuring instrument 150 measures the signal quality of the monitoring wavelength signal.

The output light intensity monitor 160 adjusts the light intensity of the transmission wavelength signal separated by the WSS 140. In addition, the output light intensity monitor 160 adjusts the output light intensity of the wavelength conversion unit 130.

### Detailed Configuration

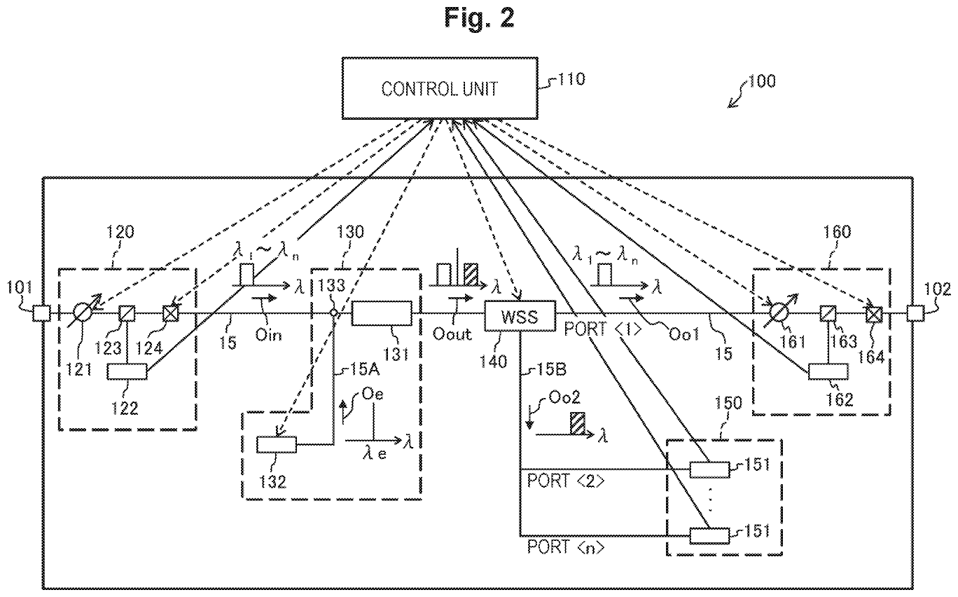

FIG. 2 is a detailed configuration diagram of the optical transmission device 100 of FIG. 1. FIG. 2 is a configuration example of outputting signal light wavelength-converted by the WSS 140 to the ports <2>0 to <n>.

### Control Unit 110

The control unit 110 determines whether or not measured input light intensity Pin is larger than preset maximum input light intensity Pmax, 110 and adjusts a VOA 121 of the input light intensity monitor 120 such that Pin=Pmax or Pin<Pmax.

The control unit 110 sets a maximum input light intensity to the nonlinear optical medium 131, closes an input-side optical shutter 124 and starts the measurement of the input light intensity by an input-side optical power meter 122 before the start of the measurement by the input-side optical power meter 122, controls the input light intensity monitor 120 so that the input light intensity measured by the input-side optical power meter 122 becomes equal to or less than the maximum input light intensity, and opens the input-side optical shutter 124 after the adjustment by the input light intensity monitor 120 is completed.

In addition, before starting the measurement of an output-side optical power meter 162, the control unit 110 closes an output-side optical shutter 164 and starts the measurement of the output light intensity by the output-side optical power meter 162, controls the output light intensity monitor 160 so that the output light intensity measured by the output-side optical power meter 162 becomes a predetermined output light intensity, and opens the output-side optical shutter 164 after the adjustment by the output light intensity monitor 160 is completed.

Input light intensity monitor 120

In FIG. 2, the input light intensity monitor 120 adjusts the input light intensity to be input to the wavelength conversion unit 130 at an appropriate light intensity.

The input light intensity monitor 120 includes a variable optical attenuator (VOA) 121, an input-side optical power meter (optical power meter) 122, a beam splitter 123, and an input-side optical shutter 124.

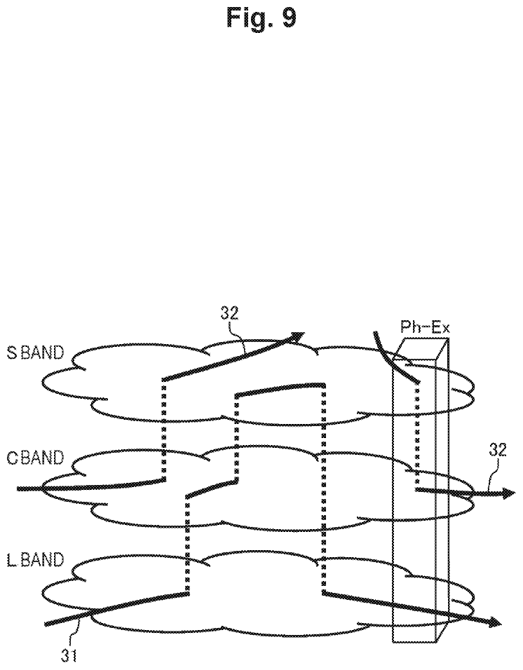

The VOA 121 receives an instruction (This means that a control signal/voltage control signal is received from the control unit 110, and the same applies hereinafter.) of the control unit 110 and variably attenuates the optically-transmitted optical signal intensity. The VOA 121 performs power management in the input light intensity monitor 120 by voltage control from the control unit 110. The VOA 121 corresponds to, for example, wavelengths of a C band, an L band, and a C+L band (FIG. 9).

The input-side optical power meter 122 measures the intensity (power) of light. Here, the input-side optical power meter 122 measures the output of the wavelength light source in the input light intensity monitor 120.

The beam splitter 123 divides an optical signal from one input channel into two or more optical signals. Here, the beam splitter 123 divides an optical signal from the VOA 121 connected to the optical input terminal 101 port <1> into an optical signal output to the wavelength conversion unit 130 side and an optical signal output to the input-side optical power meter 122. Note that the wavelength and power after division by the beam splitter 123 do not change.

The input-side optical shutter 124 performs optical shutter control (control of transmitting light only at predetermined time and shielding light at other times) at high speed by voltage control from the control unit 110. The input-side optical shutter 124 prevents the light from being input to the wavelength conversion unit 130 with the light intensity before the adjustment is completed.

### Wavelength Conversion Unit 130

The wavelength conversion unit 130 is a wavelength signal copying functional unit that generates a monitoring wavelength signal (monitoring signal light) from the transmission wavelength signal.

The wavelength conversion unit 130 includes a nonlinear optical medium 131, an excitation light source 132, and an optical multiplexer 133.

The wavelength conversion unit 130 is an all-optical wavelength conversion device including a nonlinear optical medium 131 on which both light of a light main signal to be relayed and light of excitation light emitted from the excitation light source 132 can be simultaneously incident.

Upon receiving an instruction from the control unit 110, the excitation light source 132 generates excitation light Oe having a predetermined wavelength λe. The excitation light De generated by the excitation light. source 132 enters the optical multiplexer 133 through the optical fiber 15A. The wavelength λe of the excitation light Oe is different from the wavelength λ1 of the input optical signal Oin. The light intensity of the excitation light Oe is sufficiently larger than that of the input optical signal Oin.

The optical multiplexer 133 generates light obtained by multiplexing the input optical signal Oin input from the optical fiber cable 15 and the excitation light De input from the optical fiber 15A, and sends out the light to the incident end of the nonlinear optical medium 131.

The nonlinear optical medium 131 has nonlinear optical characteristics and can generate an optical signal having a wavelength different from that of incident light. As a representative example, any one of a highly nonlinear fiber (HNLF), periodically poled lithium niobate (PPLN), and a semiconductor optical amplifier (SOA) can be used as the nonlinear optical medium 131.

### Wavelength Selection Switch (WSS) 140

The WSS 140 is connected to the light emission side of the nonlinear optical medium 131 that is an all-optical wavelength conversion device. The WSS 140 includes an optical demultiplexer (not illustrated), and the optical demultiplexer receives an instruction from the control unit 110, demultiplexes the incident light by the wavelength selection characteristic, and extracts each of two types of optical signals. In the WSS 140, the transmission optical signal Oo2 having the wavelength λ2 and the emission light Oo1 having the wavelength λ1 are emitted from a plurality of different ports <1>, <2>, . . . , and <n>.

The wavelength λ2 of the transmission optical signal Oo2 is generated based on the wavelength of the input optical signal Oin, the wavelength λe of the excitation light Oe, and the nonlinear optical characteristics of the nonlinear optical medium 131. When the input optical signal Oin having the wavelength λ1 passes through the nonlinear optical medium 131 together with the excitation light Oe, the wavelength λ2 of the wavelength-converted transmission optical signal Oo2 is generated. In addition, the emission light of the nonlinear optical medium 131 also includes a light component having the same wavelength λ1 as that before the wavelength conversion.

The transmission optical signal Oo2 having the wavelength λ2 output from the WSS 140 is sent out from the output of the optical transmission device 100 to the optical fiber cable 15 on the downstream side as a relay output. In addition, the emission light Oo1 having the wavelength λ1 output from the WSS 140 is input to the monitor measuring instrument 150 via the optical fiber 15B.

### Monitor Measuring Instrument 150

The monitor measuring instrument 150 measures the signal quality of the monitoring wavelength signal (monitoring signal light).

The monitor measuring instrument 150 is a receiver 151 (more specifically, a detector provided in the receiver) of the optical transmission device 100 (hereinafter, referred to as a receiver 151.). The receiver 151 corresponds to, for example, a reception unit of a transponder (TPD). Similarly to the transponder, it has a function of electrical termination processing, but has no function of sending out an optical signal. The receiver 151 has a function of converting an input optical signal into an electric signal and a function of processing the electric signal to detect transmission quality data. In the receiver corresponding to the transponder reception unit, unnecessary light is converted into an electric signal and processed to acquire transmission quality data.

The receiver 151 may use a spectrum analyzer, a polarization monitor, or a power meter. A spectrum analyzer is an electrical measuring instrument that displays a two-dimensional graph on a screen with a horizontal axis representing frequency and a vertical axis representing power or voltage. In a case of the spectrum analyzer, a signal-to-noise ratio is acquired. In a case of the polarization monitor, a polarization state of an optical signal is acquired, and in a case of the power meter, a light intensity is acquired.

In FIG. 2, the monitor measuring instrument 150 measures signal light that is wavelength-converted by the WSS and emitted to the ports <2>, . . . , and <n>. The receiver 151 may be prepared for each of the ports <2>, . . . , and <n>, or may be shared for a plurality of ports. Furthermore, the receiver 151 may use a combination of a plurality of types of measuring instruments.

### Output Light Intensity Monitor 160

The output light intensity monitor 160 includes a VOA 161, an output-side optical power meter 162, a beam splitter 163, and an output-side optical shutter 164.

In response to an instruction from the control unit 110, the VOA 161 variably attenuates the optically-transmitted optical signal intensity. The VOA 161 performs power management in the output light intensity monitor 160 by voltage control from the control unit 110.

The output-side optical power meter 162 measures the intensity (power) of light incident on the output light intensity monitor 160.

The beam splitter 163 divides an optical signal from one input channel into two or more optical signals. Here, the beam splitter 163 divides an optical signal from the VOA 161 connected to the port <1> into an optical signal output to the optical output terminal 102 side and an optical signal output to the output-side optical power meter 162.

The output-side optical shutter 164 performs optical shutter control at high speed by voltage control from the control unit 110. The output-side optical shutter 164 prevents the light from being output to the outside with the light intensity before the adjustment is completed.

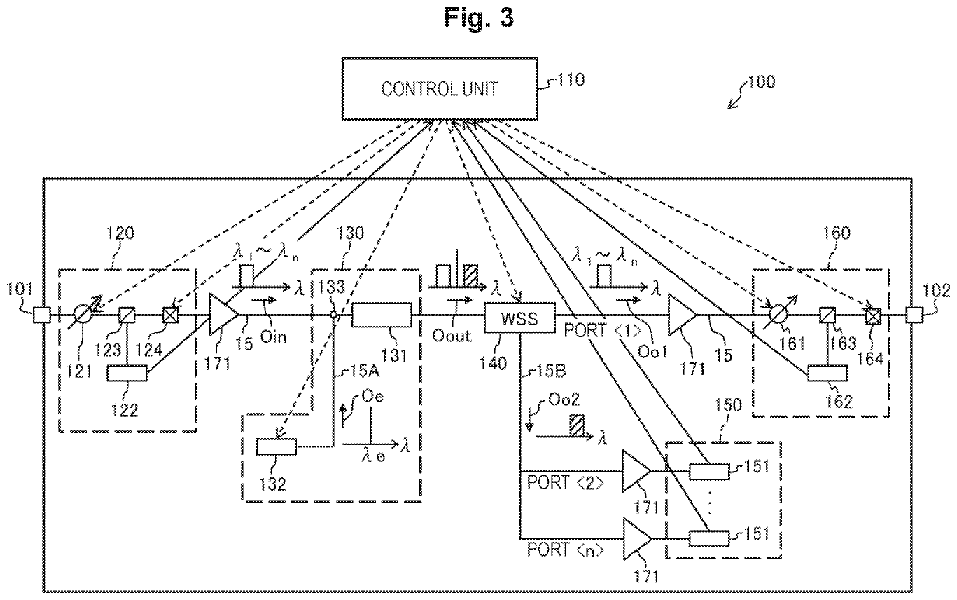

FIG. 3 is a detailed configuration diagram in which an optical amplifier 171 is disposed in the optical transmission device 100 of FIG. 2. The same components as those in FIG. 2 are denoted by the same reference numerals.

In the optical transmission device 100 illustrated in FIG. 3, the optical amplifier 171 that amplifies the output of the input light intensity monitor 120 is disposed on the output side of the input light intensity monitor 120 (the preceding stage of the wavelength conversion unit 130). In addition, the optical amplifier 171 that amplifies the output of the WSS 140 is disposed at each of the ports <1>, <2>, . . . , and <n>of the WSS 140.

In the optical transmission device 100 illustrated in FIG. 3, in a case where the conversion efficiency/gain of the input light intensity monitor 120 is low, the optical amplifier 171 is added to the output side (preceding stage of the wavelength conversion unit 130) of the input light intensity monitor 120, and the output light of the input light intensity monitor 120 is amplified. Furthermore, in a case where the conversion efficiency/gain of the nonlinear optical medium 131 is low, the optical transmission device 100 adds the optical amplifier 171, and the output light of the nonlinear optical medium 131 is amplified. Note that only one of the optical amplifier 171 on the output side of the input light intensity monitor 120 and the optical amplifier 171 on the output side of the nonlinear optical medium 131 may be disposed in accordance with the conversion efficiency/gain.

Hereinafter, the operation of the optical transmission device 100 configured as described above will be described.

### Operation Example of Outputting Signal Light Wavelength-Converted by WSS to Ports <2> to <n>

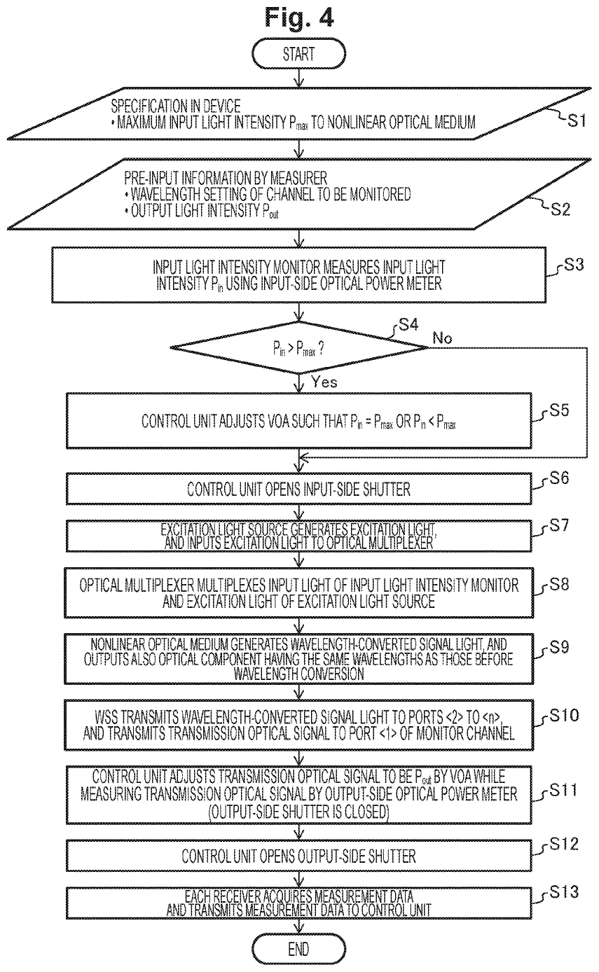

FIG. 4 is a flowchart illustrating an operation of outputting signal light wavelength-converted by the WSS of the optical transmission device 100 illustrated in FIG. 2 to the ports <2> to <n>.

In step S1, the control unit 110 sets the maximum input light intensity Pmax to the nonlinear optical medium 131, which is a specification in the optical transmission device 100, using an input unit (not illustrated).

In step S2, the measurer sets pre-input information (wavelength setting of channel to be monitored and output light intensity Pout). Here, the wavelength setting of the channel to be monitored is set such that the signal light wavelength-converted by the WSS is output to the ports <2> to <n>.

In step S3, the input light intensity monitor 120 measures the input light intensity Pin using the input-side optical power meter 122.

In step S4, the control unit 110 determines whether or not the measured input light intensity Pin is larger than a preset maximum input light intensity Pmax (Pin>Pmax).

If Pin>Pmax (S4: Yes), in step S5, the control unit 110 adjusts the VOA 121 of the input light intensity monitor 120 such that Pin=Pmax or Pin<Pmax. If Pin≤Pmax (S4: No), the process directly proceeds to step S6.

Here, in the wavelength conversion by the nonlinear optical medium 131, when high input light intensity is incident, transmission quality deterioration occurs due to a nonlinear phenomenon such as gain saturation or inter-channel crosstalk. In the present embodiment, in order to suppress transmission quality deterioration due to a nonlinear phenomenon, the maximum input light intensity Pmax to the nonlinear optical medium 131 is set in advance.

In step S6, the control unit 110 opens the input-side optical shutter 124 of the input light intensity monitor 120. As a result, as illustrated in a void waveform illustrated on an arrow of the input optical signal Oin in FIG. 2, the input optical signal (hereinafter, simply referred to as wavelength λ1 to λn input optical signal) Oin of each component having the wavelength λ1 to λn is input from the input light intensity monitor 120 to the optical multiplexer 133 of the wavelength conversion unit 130 through the optical fiber cable 15. Note that, in order to indicate that the input optical signal Oin in FIG. 2 does not have a single wavelength, the void waveform is represented in a rectangular shape (the same applies to a representation method of wavelength-converted signal light described later).

In step S7, the excitation light source 14 generates the excitation light Oe having a single wavelength λe, and inputs the excitation light Oe having the wavelength λe to the optical multiplexer 133 through the optical fiber 15A.

In step S8, the optical multiplexer 133 multiplexes the input optical signal Oin having the wavelengths λ1 to λn of the input light intensity monitor 120 and the excitation light Oe of the excitation light source 14, and inputs the multiplexed signal to the nonlinear optical medium 131. Note that the light intensity of the excitation light Oe is sufficiently larger than that of the input optical signal Oin.

In step S9, the nonlinear optical medium 131 of the wavelength conversion unit 130 passes both the input optical signal Oin having the wavelengths λ1 to λn and the excitation light Oe having the wavelength λe, thereby generating signal light Oo2 obtained by wavelength-converting the input optical signal Oin having the wavelengths λ1 to λn in mirror-symmetry with the excitation light Oe as the center wavelength on the basis of the nonlinear optical characteristics of the nonlinear optical medium 131, and also outputting the wavelength-converted signal light Oo2 and an optical component Oo1 having the same wavelengths λ1 to λn as those before the wavelength conversion. That is, the emission light Oout of the nonlinear optical medium 131 also includes the wavelength-converted signal light Oo2 (see the hatched waveform indicated on the arrow of the emission light Oout in FIG. 2) and the optical component Oo1 having the same wavelengths λ1 to λn as those before the wavelength conversion (see the void waveform indicated on the arrow of the emission light Oout in FIG. 2).

The emission light Oout emitted from the nonlinear optical medium 131 includes an optical component Oo1 having wavelengths λ1 to λn, a wavelength λe, and wavelength-converted signal light Oo2. The wavelength-converted signal light Oo2 is a component generated by the wavelength conversion of the input optical signal Oin accompanying the passage of the nonlinear optical medium 131. The light intensity of the component of the wavelength-converted signal light Oo2 included in the emission light Oout depends on the nonlinear optical medium and the excitation light intensity, and can be equivalent to the input optical signal Oin. Therefore, wavelength conversion can be performed without attenuating light intensity.

Further, the light intensity of the optical component Oo1 having the wavelengths λ1 to λn included in the emission light Oout is equal to that of the input optical signal Oin. Therefore, an optical signal having the same wavelengths λ1 to λn as those before the wavelength conversion and other than the main signal can be extracted from the output of the nonlinear optical medium 131 with sufficiently high light intensity.

In step S10, the WSS 140 transmits the wavelength-converted signal light Oo2 as monitoring signal light to the ports <2> to <n>, and transmits the transmission optical signal Oo1 to the port <1> of the monitor channel.

In step S11, the control unit 110 adjusts the transmission optical signal Oo1 to be Pout by the VOA 161 while measuring the transmission optical signal Oo1 by the output-side optical power meter 162 (the output-side optical shutter 164 is closed).

In step S12, the control unit 110 opens the output-side optical shutter 164 of the output light intensity monitor 160.

In step S13, each receiver 151 of the monitor measuring instrument 150 measures the transmission quality of the monitoring signal light Oo2 transmitted to the ports <2> to <n> to acquire measurement data, transmits the measurement data to the control unit 110, and ends the processing of this flow.

Here, since the monitoring signal light Oo2 having a sufficiently high light intensity is input to each receiver 151, each receiver 151 can easily detect the transmission quality data at the position of the corresponding relay node.

The output light intensity can be adjusted by the procedure of the above flow. In addition, the output light intensity can be made the same as the input light intensity.

### Operation Example of Outputting Signal Light Wavelength-Converted by WSS to Port <1>

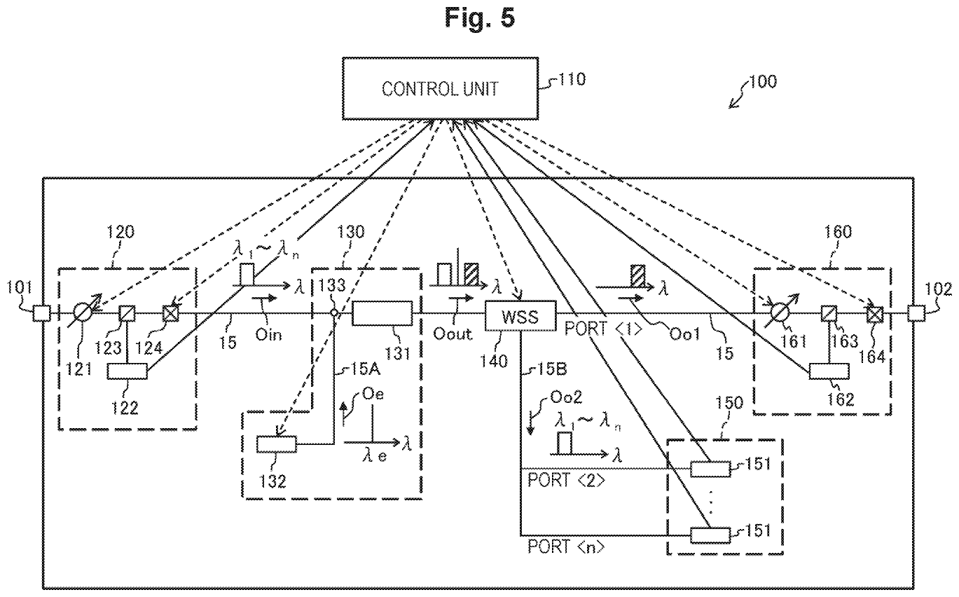

FIG. 5 is a configuration example of outputting the signal light wavelength-converted by the WSS 140 to the port <1>. The same components as those in FIG. 2 are denoted by the same reference numerals.

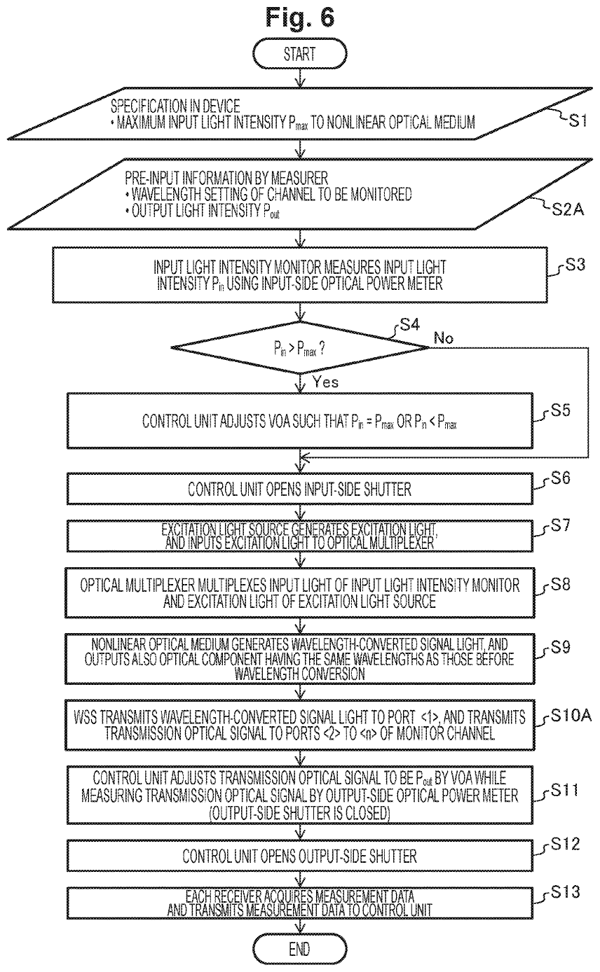

FIG. 6 is a flowchart illustrating an operation of outputting signal light wavelength-converted by the WSS of the optical transmission device 100 illustrated in FIG. 5 to the port <1>. The same processing portions as those in FIG. 4 are denoted by the same reference numerals, and description of overlapping portions is omitted.

Step S2A is obtained by replacing step S2 in FIG. 4. In step S2A, the measurer sets pre-input information (wavelength setting of channel to be monitored and output light intensity Pout). Here, the wavelength setting of the channel to be monitored is set such that the signal light wavelength-converted by WSS is output to the port <1>.

Step S10A is obtained by replacing step S10 in FIG. 4. In step S10A, the WSS 140 transmits the wavelength-converted signal light Oo2 to the port <1> as the transmission optical signal Oo1, and transmits the transmission optical signal Oo2 having the same wavelengths λ1 to λn as those before the wavelength conversion to the ports <2> to <n> of the monitor channel as the monitoring signal light.

The output light intensity can be adjusted by the procedure of the above flow. In addition, the output light intensity can be made the same as the input light intensity.

In addition, since the light after wavelength conversion is used as transmission signal light, the light can also be used as a monitoring device and a wavelength converter.

### Effects

As described above, an optical transmission device 100 (FIGS. 1, 2, 3, and 5) that is mountable on at least one optical relay node of an optical transmission system 1 (FIG. 10) in which an optical transmission node capable of transmitting an optical signal and an optical reception node capable of receiving an optical signal are connected via an optical transmission line and one or more optical relay nodes are connected to an intermediate position of the optical transmission line, the optical transmission device including: an input light intensity adjustment unit (input light intensity monitor 120) that adjusts light intensity of a transmission wavelength signal input to the optical relay node; a wavelength conversion unit 130 that converts a wavelength of the transmission wavelength signal whose light intensity has been adjusted by the input light intensity adjustment unit; a wavelength separation unit (WSS 140) that divides a transmission wavelength signal to be relayed into a transmission wavelength signal whose wavelength is the same as that before wavelength conversion and a monitoring wavelength signal other than the transmission wavelength signal; an output light intensity adjustment unit (output light intensity monitor 160) that adjusts light intensity of the transmission wavelength signal separated by the wavelength separation unit; a measurement unit (monitor measuring instrument 150) that measures transmission quality of the monitoring wavelength signal separated by the wavelength separation unit; and a control unit 110 that controls the input light intensity adjustment unit, the wavelength separation unit, and the output light intensity adjustment unit.

In this way, in the input light intensity adjustment unit (input light intensity monitor 120), the transmission quality deterioration can be suppressed by appropriately adjusting the input light intensity. The wavelength conversion unit 130 generates a monitoring wavelength signal from the transmission wavelength signal. The output light intensity adjustment unit (output light intensity monitor 160) appropriately outputs the light intensity of the transmission wavelength signal to be output. The measurement unit (monitor measuring instrument 150) measures the transmission quality of the monitoring wavelength signal. These functional units are controlled by the control unit 110. Therefore, it is possible to realize the transmission quality monitoring device capable of autonomously adjusting the output light intensity. As described above, the optical transmission device 100 can minimize the deterioration of the transmission performance of the transmission wavelength signal or eliminate the need for re-adjustment of the optical level diagram. a result, it is possible to introduce the optical transmission device while minimizing the influence on the existing optical transmission device.

In addition, since the optical transmission device 100 relays the transmission wavelength signal to be relayed as an optical signal and sends out the optical signal to the optical fiber cable 15 on the downstream side without performing electrical termination processing on the transmission wavelength signal to be relayed, it is possible to prevent an increase in delay due to the relay processing. In addition, since it is not necessary to use an optical splitter to extract an optical signal input to the measurement unit (monitor measuring instrument 150), it is possible to suppress a decrease in the light intensity of the transmission wavelength signal. Therefore, the control unit 110 can acquire the transmission quality data of the relay node such as the optical transmission device that does not perform the electrical termination processing. For example, in a case where a fault occurs, the control unit 110 can discriminate the presence or absence of the fault occurrence for each section, on the basis of the transmission quality data at the position of each relay node.

Furthermore, in the optical transmission device 100, the control unit 110 sets the ports <1>, <2>, . . . , and <n>of the WSS 140, so that the transmission wavelength signal and the wavelength-converted signal light can be exchanged. For example, the optical transmission device 100 transmits each optical component of the wavelengths λ1 to λn, detects each optical component of the wavelength-converted signal light as a monitoring wavelength signal, and acquires transmission quality data (FIGS. 2, 3, and 4).

Furthermore, the optical transmission device 100 transmits each optical component of the wavelengths λ1 to λn, detects each optical component of the wavelengths λ1 to λn as an extracted signal, and acquires transmission quality data (FIGS. 5 and 6). In this case, the optical transmission device 100 can acquire the transmission quality data even when wavelength conversion is not performed. That is, since the light after the wavelength conversion is used as transmission signal light, it can also be used as a monitoring device and also as a wavelength converter.

An optical transmission device 100 (FIGS. 1, 2, 3, and 5) includes an excitation light source 132 (FIGS. 2, 3, and 5) that emits excitation light having a wavelength different from a wavelength before wavelength conversion of a transmission wavelength signal to be relayed, in which a wavelength conversion unit 130 is a nonlinear optical medium 131 (FIGS. 2, 3, and 5) on which both light of the transmission wavelength signal to be relayed and light of the excitation light emitted from the excitation light source 132 can be simultaneously incident, and a wavelength separation unit (WSS 140) separates the emission light from the nonlinear optical medium 131 into an optical component of the wavelength after the wavelength conversion and an optical component of the wavelength before the wavelength conversion.

In this way, the light intensity of the component of the wavelength-converted signal light included in the emission light Oout (FIGS. 2, 3, and 5) from the nonlinear optical medium 131 depends on the nonlinear optical medium 131 and the excitation light intensity, and can be made equal to the input optical signal Oin. Therefore, wavelength conversion can be performed without attenuating light intensity. In addition, the light intensity of the optical components having the wavelengths λ1 to λn included in the emission light Oout is equal to that of the input optical signal Oin. Therefore, an optical signal having the same wavelengths λ1 to λn as those before the wavelength conversion and other than the main signal can be extracted from the output of the nonlinear optical medium 131 with sufficiently high light intensity.

The input light intensity adjustment unit (input light intensity monitor 120) includes an input-side optical shutter 124 (FIGS. 2, 3, and 5) that shields the input of the transmission wavelength signal so that the transmission wavelength signal is not input to the wavelength conversion unit 130 with the light intensity before the adjustment is completed, and the output light intensity adjustment unit (output light intensity monitor 160) includes an output-side optical shutter 164 (FIGS. 2, 3, and 5) that shields the output of the transmission wavelength signal so that the transmission wavelength signal is not output with the light intensity before the adjustment is completed.

In this way, the input light intensity monitor 120 and the output light intensity monitor 160 include the input-side optical shutter 124 and the output-side optical shutter 164, respectively, so that the input light intensity adjustment and the output light intensity adjustment can be executed in an environment in which the optical transmission line is temporarily closed to prevent unnecessary incidence and emission (FIGS. 4 and 6).

In the optical transmission device 100 (FIGS. 1, 2, 3, and 5), the input light intensity adjustment unit (input light intensity monitor 120) includes an input-side adjustment unit (VOA121) (FIGS. 2, 3, and 5) that adjusts the input light intensity to the nonlinear optical medium 131, an input-side optical power meter 122 (FIGS. 2, 3, and 5) that measures the input light intensity, and an input-side optical shutter 124 (FIGS. 2, 3, and 5) that shields the input of the transmission wavelength signal. The control unit 110 (FIGS. 2, 3, and 5) sets the maximum input light intensity to the nonlinear optical medium 131, closes the input-side optical shutter 124 to start the measurement of the input light intensity by the input-side optical power meter 122 before the start of the measurement of the input-side optical power meter 122, controls the input-side adjustment unit such that the input light intensity measured by the input-side optical power meter 122 becomes equal to or less than the maximum input light intensity, and opens the input-side optical shutter 124 after the adjustment by the input-side adjustment unit is completed.

With this configuration, the input light intensity adjustment can be executed (FIGS. 4 and 6) in an environment in which unnecessary incidence to the optical transmission device 100 is prevented, and the input light intensity adjustment can be accurately performed.

In an optical transmission device 100 (FIGS. 1, 2, 3, and 5), an output light intensity adjustment unit (output light intensity monitor 160) includes an output-side adjustment unit (VOA 161) (FIGS. 2, 3, and 5) that adjusts an output amount of light such that output light intensity becomes a predetermined output light intensity, an output-side optical power meter 162 that measures the output light intensity, and an output-side optical shutter 164 that shields output of a transmission wavelength signal. Before starting measurement of the output-side optical power meter 162, a control unit 110 closes the output-side optical shutter 164 and starts measurement of the output light intensity by the output-side optical power meter 162, controls the output-side adjustment unit such that the output light intensity measured by the output-side optical power meter 162 becomes the predetermined output light intensity, and opens the output-side optical shutter 164 after the adjustment by the output adjustment unit is completed.

In this way, it is possible to execute (FIGS. 4 and 6) the adjustment of the input light intensity and the adjustment of the output light intensity in the environment in which the emission from the optical transmission device 100 is prevented, and it is possible to suppress the influence on the optical transmission device and the like at the subsequent stage.

In the optical transmission device 100 (FIGS. 1, 2, 3, and 5), an optical amplifier 171 (FIG. 3) that amplifies signal light is disposed on the output side of the input light intensity adjustment unit (input light intensity monitor 120) and/or the output side of the wavelength separation unit (WSS 140).

In this way, by disposing the optical amplifier 171 on the output side of the input light intensity monitor 120, the input light can be amplified in a case where the input light intensity is small. In addition, by disposing the optical amplifier 171 immediately after the output from the WSS 140, the output light can be amplified in a case where the gain/conversion efficiency of the nonlinear optical medium 131 is low.

Note that, in the network controller 20 (FIG. 10) of the optical transmission system 1, it is generally assumed that “Pre-FEC BER” is used as the transmission quality data detected by the transponder 11 of each optical relay node. On the other hand, the detector 11A and the transponder 11 can acquire data such as a wavelength dispersion compensation amount, a polarization mode dispersion, and a polarization-dependent loss in addition to “Pre-FEC BER” by electric signal processing of communication data. Therefore, the network controller 20 can also collect data such as the wavelength dispersion compensation amount, the polarization mode dispersion, and the polarization-dependent loss from each optical relay node on which the detector 11A or the transponder 11 is mounted, and use the collected data as learning data of machine learning. This helps to realize failure prediction in the optical network without the electrical termination processing.

Among the processing described in the above embodiments, all or a part of the processing described as being performed automatically can be performed manually, or all or a part of the processing described as being performed manually can be performed automatically by a known method. In addition, the processing procedure, the control procedure, the specific name, and the information including various data and parameters illustrated in the document and the drawings can be arbitrarily changed unless otherwise specified.

In addition, each component of each device illustrated in the drawings is functionally conceptual, and is not necessarily physically configured as illustrated in the drawings. That is, a specific form of distribution and integration of each device is not limited to the illustrated form, and all or a part thereof can be functionally or physically distributed and integrated in an arbitrary unit according to various loads, usage conditions, and the like.

In addition, some or all of the above-described configurations, functions, processing units, processing means, and the like may be implemented by hardware, for example, by designing with an integrated circuit.

Furthermore, the individual components, functions, or the like described above may be implemented by software for interpreting and executing a program for causing a processor to implement the individual functions. Information such as a program, a table, or a file for implementing each function can be held in a recording device such as a memory, a hard disk, or a solid state drive (SSD), or in a recording medium such as an integrated circuit (IC) card, a secure digital (SD) card, or an optical disc.

### REFERENCE SIGNS LIST

1 optical transmission system
10-1, 10-2, 10-3, 10-4, 10-5 optical transmission device
11 transponder
11A detector
13 all-optical wavelength conversion unit
14 excitation light source
15 optical fiber cable
15A, 15B optical fiber
16 optical multiplexer
17 nonlinear optical medium
18 optical demultiplexer
20 network controller
31, 32 optical communication link
100 optical transmission device
110 control unit
101 optical input terminal
102 optical output terminal
120 input light intensity monitor (input light intensity adjustment unit)
121, 161 VOA
122 input-side optical power meter
123, 163 beam splitter
124 input-side optical shutter
130 wavelength conversion unit
131 nonlinear optical medium
132 excitation light source
133 optical multiplexer
140 wavelength selection switch (WSS) (wavelength separation unit)
150 monitor measuring instrument (measurement unit)
151 receiver
160 output light intensity monitor (output light intensity adjustment unit)
162 output-side optical power meter
164 output-side optical shutter
171 optical amplifier

1. An optical transmission device that is mountable in at least one optical relay node of an optical transmission system in which an optical transmission node capable of transmitting an optical signal and an optical reception node capable of receiving an optical signal are connected via an optical transmission line and one or more optical relay nodes are connected to an intermediate position of the optical transmission line, the optical transmission device comprising:
an input light intensity adjustment unit, implemented with hardware including at least one integrated circuit, configured to adjust an input light intensity of a transmission wavelength signal input to the optical relay node;
a wavelength conversion unit, implemented with hardware including at least one integrated circuit, configured to convert a first wavelength of a transmission wavelength signal whose input light intensity has been adjusted by the input light intensity adjustment unit to a second wavelength;
a wavelength separation unit, implemented with hardware including at least one integrated circuit, configured to divide the transmission wavelength signal to be relayed into the transmission wavelength signal having the first wavelength and a monitoring wavelength signal other than the transmission wavelength signal;
an output light intensity adjustment unit, implemented with hardware including at least one integrated circuit, configured to adjust an output light intensity of the transmission wavelength signal separated by the wavelength separation unit;
a measurement unit, implemented with hardware including at least one integrated circuit, configured to measure a transmission quality of the monitoring wavelength signal separated by the wavelength separation unit; and
a control unit configured to control the input light intensity adjustment unit, the wavelength separation unit, and the output light intensity adjustment unit.

2. The optical transmission device according to claim 1, comprising an excitation light source configured to emit excitation light having a second wavelength different from the first wavelength of the transmission wavelength signal to be relayed, wherein
the wavelength conversion unit comprises a nonlinear optical medium on which both the transmission wavelength signal to be relayed and the excitation light emitted from the excitation light source can be incident simultaneously, and
the wavelength separation unit is configured to separate emission light from the nonlinear optical medium into a light component having a third wavelength after wavelength conversion and a light component having the first wavelength before wavelength conversion.

3. The optical transmission device according to claim 2, wherein
the input light intensity adjustment unit comprises an input-side optical shutter configured to shield an input of the transmission wavelength signal and prevent the transmission wavelength signal from being input to the wavelength conversion unit with the input light intensity before the adjustment is completed, and
the output light intensity adjustment unit comprises an output-side optical shutter configured to shield an output of the transmission wavelength signal and prevent the transmission wavelength signal from being output with the output light intensity before the adjustment is completed.

4. The optical transmission device according to claim 2, wherein
the input light intensity adjustment unit comprises:
an input-side adjustment unit configured to adjust the input light intensity to the nonlinear optical medium;
an input-side optical power meter configured to measure the input light intensity; and
an input-side optical shutter configured to shield an input of the transmission wavelength signal, and wherein the control unit is configured to
set a maximum input light intensity to the nonlinear optical medium,
close the input-side optical shutter, before measurement of the input-side optical power meter is started, and start measurement of the input light intensity by the input-side optical power meter,
control the input-side adjustment unit to make the input light intensity measured by the input-side optical power meter equal to or less than the maximum input light intensity, and
open the input-side optical shutter after the adjustment by the input-side adjustment unit is completed.

5. The optical transmission device according to claim 2, wherein
the output light intensity adjustment unit comprises:
an output-side adjustment unit configured to adjust an output amount of light so that the output light intensity becomes a predetermined output light intensity;
an output-side optical power meter configured to measure the output light intensity; and
an output-side optical shutter configured to shield an output of the transmission wavelength signal, and
wherein the control unit is configured to
close the output-side optical shutter, before measurement of the output-side optical power meter is started, and start measurement of the output light intensity by the output-side optical power meter,
control the output-side adjustment unit to make the output light intensity measured by the output-side optical power meter the predetermined output light intensity; and
open the output-side optical shutter after the adjustment by the output-side adjustment unit is completed.

6. The optical transmission device according to claim 1, wherein an optical amplifier configured to amplify a signal light is on an output side of the input light intensity adjustment unit and/or an output side of the wavelength separation unit.

7. An optical transmission method of an optical transmission system in which an optical transmission node capable of transmitting an optical signal and an optical reception node capable of receiving an optical signal are connected via an optical transmission line, and one or more optical relay nodes are connected to an intermediate position of the optical transmission line, the optical transmission method comprising:
adjusting, by the optical relay node of the optical transmission system, an input light intensity of a transmission wavelength signal input to the optical relay node;
converting, by the optical relay node, a first wavelength of a transmission wavelength signal whose input light intensity has been adjusted to a second wavelength;
dividing, by the optical relay node, the transmission wavelength signal to be relayed into the transmission wavelength signal having the first wavelength and a monitoring wavelength signal other than the transmission wavelength signal;
adjusting, by the optical relay node, an output light intensity of the transmission wavelength signal; and
measuring, by the optical relay node, a transmission quality of the monitoring wavelength signal.

8. An optical transmission device that is mountable in at least one optical relay node of an optical transmission system in which an optical transmission node capable of transmitting an optical signal and an optical reception node capable of receiving an optical signal are connected via an optical transmission line and one or more optical relay nodes are connected to an intermediate position of the optical transmission line, the optical transmission device comprising:
an input light intensity adjustment unit, implemented with hardware including at least one integrated circuit, configured to adjust an input light intensity of a transmission wavelength signal input to the optical relay node;
a wavelength conversion unit, implemented with hardware including at least one integrated circuit, configured to convert a first wavelength of a transmission wavelength signal whose input light intensity has been adjusted by the input light intensity adjustment unit into a second wavelength;
a wavelength separation unit, implemented with hardware including at least one integrated circuit, configured to divide the transmission wavelength signal to be relayed into a monitoring wavelength signal having the first wavelength and the transmission wavelength signal that is signal light after wavelength conversion;
an output light intensity adjustment unit, implemented with hardware including at least one integrated circuit, configured to adjust an output light intensity of the transmission wavelength signal separated by the wavelength separation unit;
a measurement unit, implemented with hardware including at least one integrated circuit, configured to measure a transmission quality of the monitoring wavelength signal separated by the wavelength separation unit; and
a control unit, implemented with hardware including at least one integrated circuit, configured to control the input light intensity adjustment unit, the wavelength separation unit, and the output light intensity adjustment unit.

9. An optical transmission method of an optical transmission system in which an optical transmission node capable of transmitting an optical signal and an optical reception node capable of receiving an optical signal are connected via an optical transmission line, and one or more optical relay nodes are connected to an intermediate position of the optical transmission line, the optical transmission method comprising:
adjusting, by the optical relay node of the optical transmission system, an input light intensity of a transmission wavelength signal input to the optical relay node;
converting, by the optical relay node, a first wavelength of a transmission wavelength signal whose input light intensity has been adjusted to a second wavelength;
dividing, by the optical relay node, the transmission wavelength signal to be relayed into a monitoring wavelength signal having the first wavelength and the transmission wavelength signal that is signal light after wavelength conversion;
adjusting, by the optical relay node, an output light intensity of the transmission wavelength signal; and
measuring, by the optical relay node, a transmission quality of the monitoring wavelength signal.
